(19) United States
(12) Patent Application Publication
(10) Pub. No.: US 2015/0012379 A1
(43) Pub. Date: Jan. 8, 2015

(54) SYSTEM AND METHODS OF AN AGGREGATE VIRTUAL GIFT REGISTRY, CONTENT SHARING AND MONETARY CONTRIBUTION

(71) Applicants: Cynthia Fulinara, San Diego, CA (US); Michelle Gonzalez, Mililani, HI (US)

(72) Inventors: Cynthia Fulinara, San Diego, CA (US); Michelle Gonzalez, Mililani, HI (US)

(73) Assignee: Gift Vine, LLC, Mililani, HI (US)

(21) Appl. No.: 13/933,124

(22) Filed: Jul. 2, 2013

(51) Int. Cl. G06Q 30/06

(52) U.S. Cl. CPC G06Q 30/0633
USPC 705/26.8

(57) ABSTRACT

The embodiments described herein relate generally to a comprehensive online gift registry system, including monetary donations, over a network displaying images and data collected from third-party retailers and user sharing content in a social networking environment.

### CROSS-REFERENCE TO RELATED APPLICATION

This application seeks to claim the benefit under 35 U.S.C. §119(e) of U.S. Provisional Application No. 61/666,511 filed Jun. 29, 2012 entitled “Systems and Method of an Aggregate Virtual Gift Registry, Content Sharing and Vendor Contribution,” which is incorporated herein by reference in its entirety.

### RELATED ART

Traditional gift registries limit users to specific retailers and events. This conventional approach doesn't take into account increased online shopping and user sharing via social networking. Current registries cater to specific events such as wedding, baby, and home. However, a gap exists between current registries and specialty gift giving sites. Similar and existing online gift registries may collect information from a plurality of retailers over a network system, and display only items of those retailers.

### TECHNICAL FIELD

Various embodiments of the present invention are directed to a system and methods for an interactive and all-inclusive online gift registry system. The system and methods enable a user to create a comprehensive gift registry by use computing devices, including but not limited to: desktop computers, laptop computers, tablets, smart phones, and personal data assistants from third-party retailer's websites. In addition, monetary donations can be made directly to the user on registry system by way of third-party (PayPal).

### SUMMARY

The primary objective of the invention is to provide an all-inclusive online gift registry system that allows users to collect items from countless online retailers onto User's gift registry page, or enable feature to allow monetary donations by Guests. Such registry system enables User to register for any event, including non-profit agencies.

Another object of the invention is to enable and allow tablets and smart phones to scan the barcode or QR of a physical item and upload it onto the registry system User's registry page.

An added object of the invention is to allow Guest access, by way of a system generated code or manual registry search using specific event details without registration. A further object of the invention allows the user to track items purchased by guests or donations made on an Activity Page. Guests are also able to identify items remaining as the image on the registry as they are in color and not grey scale.

Other objects of this invention allows Users and Guests to interact by way of social media sites, such as but not limited to, Facebook and Twitter; and commenting directly on the user registry page. User has the option to turn on social media button on their registry profile. When User adds items to their registry, the items are interfaced onto their social media page for others to view.

### BRIEF DESCRIPTION OF THE DRAWINGS

Various embodiments disclosed herein are described in detail with reference to the following figures. The images are provided for purposes of illustration only and to facilitate the reader's understanding of the invention; and shall not be considered limiting the scope or applicability of the embodiments. It should be noted that for clarity and ease of illustration, these drawings are not necessarily made to scale.

FIG. 1: Display of registry system process flow chart

FIG. 2: A screen capture of the main page of the present invention. Includes User and Guest log-in, registry search and new user registration.

FIG. 3: A screen capture of a new user registration.

FIG. 4: A screen capture of a manual registry search based on specific User event details.

FIG. 5: A screen capture of the User's registry page of the present invention. Option to create up to 5 registries such as children's birthday, anniversary, graduation, etc. User is also able to manage registry on this page.

FIG. 6: A screen capture of a registry creation. User information such as registry title, event type, event date, and shipping information is required. User information will reflect on registry search and shipping information is used for Guest purchase.

FIG. 7: A screen capture to add an item to registry system. Option to request donation or item, image upload and item details such as cost, quantity, color, size, etc.

FIG. 8: A screen capture to illustrate image parsing. The URL can be added to display an image of the item. The User is to select the image, as parsing can result with multiple images.

FIG. 9: A screen capture of User's registry page

FIG. 10: A screen capture to display registry page visible to Guests. Images of requested items/donations from Users appear in rows and columns.

FIG. 11: A screen capture of detailed item information once selected on registry. This also enables guest to purchase directly on retailers website or inform user of purchase, as well as comment for social interaction.

FIG. 12: A screen capture of the Activity Report. Used to track items fulfilled or items pending, monetary donations made, and by which Guest.

FIG. 13: A screen capture of the distribution code email message sent to Guest. User can email Guest access via registry system.

FIG. 14: A sketch of an exemplary designed to enable direct item scanning by way of smart phone or tablet and QR or barcode scanner application. Items can be uploaded and added to registry in addition to online shopping.

### DETAILED DESCRIPTION

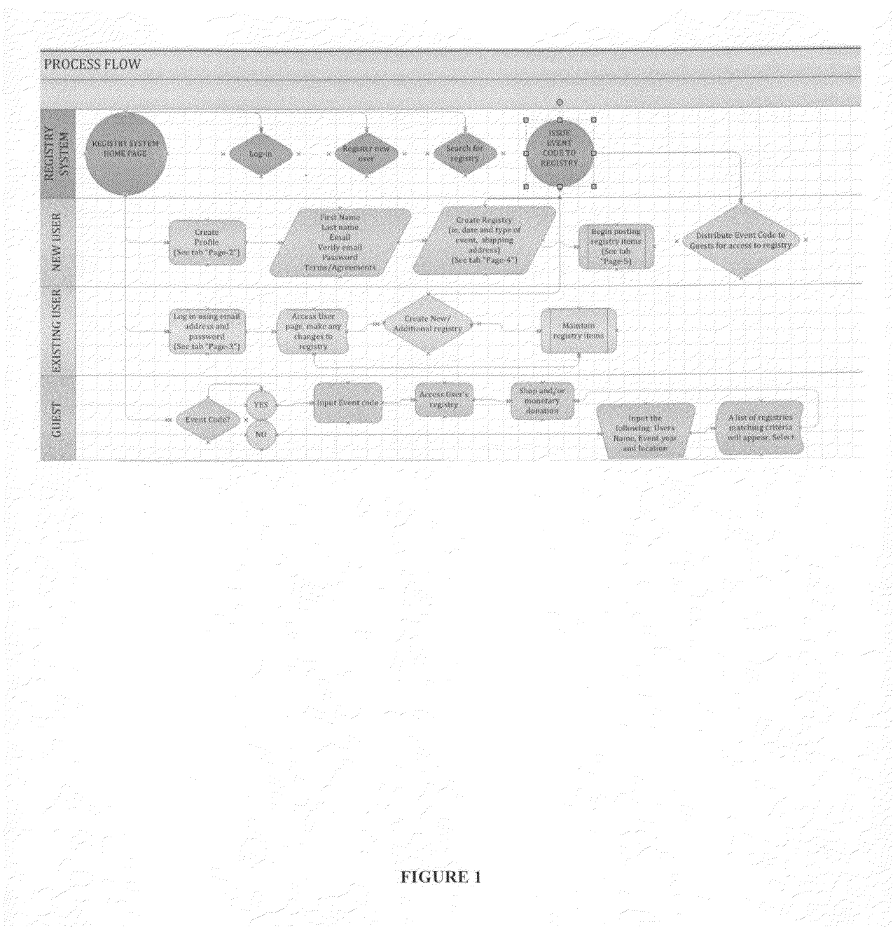

FIG. 1 illustrates the process flow of the present invention. The main function of the registry system is to enable Users to collect items from countless online retailers onto Users gift registry page, or enable feature to allow monetary donations by Guests.

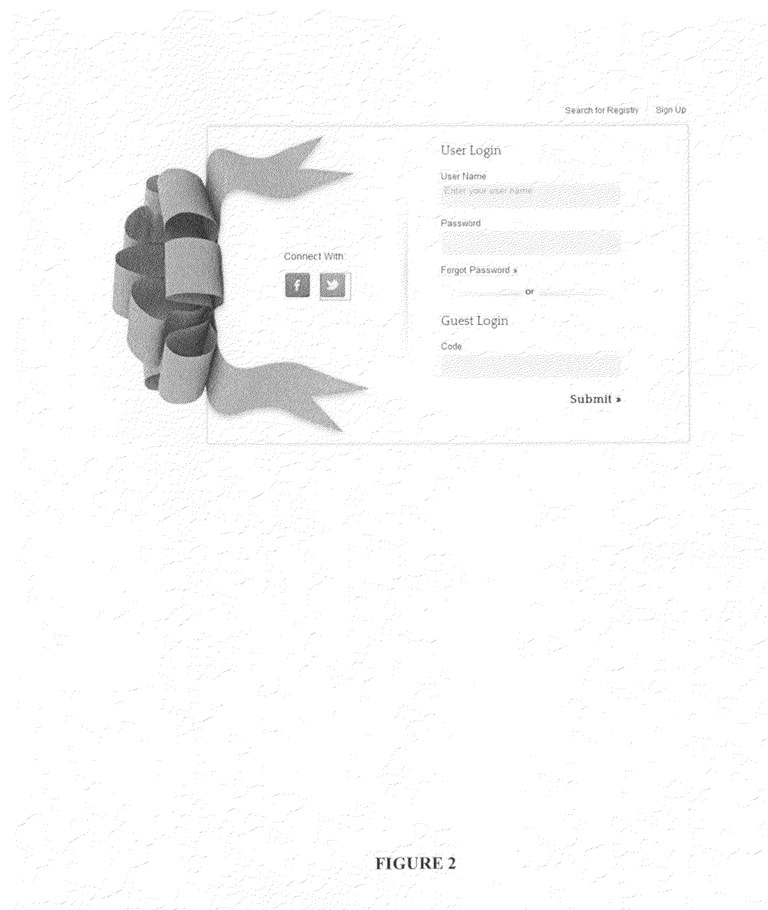

FIG. 2 displays the main page of the present invention. Users who have established an account with the registry system, can login using email address and password. User can also sign-in by using social media user name and password. Guests can access User's registry with system generated code provided by the User. In an effort to protect User's privacy, Guest can only access registry by system generated code or knowing specific details of User's event.

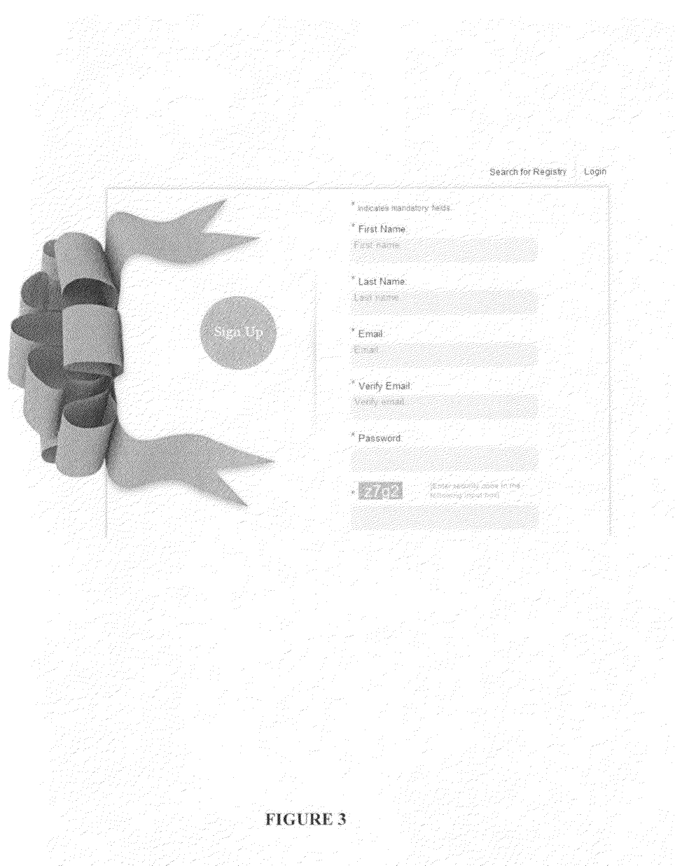

FIG. 3 displays a sign-in page for new users. Information requested, such as name, email address and password, is required to access to registry system and to create a registry. Information will be saved for registry search.

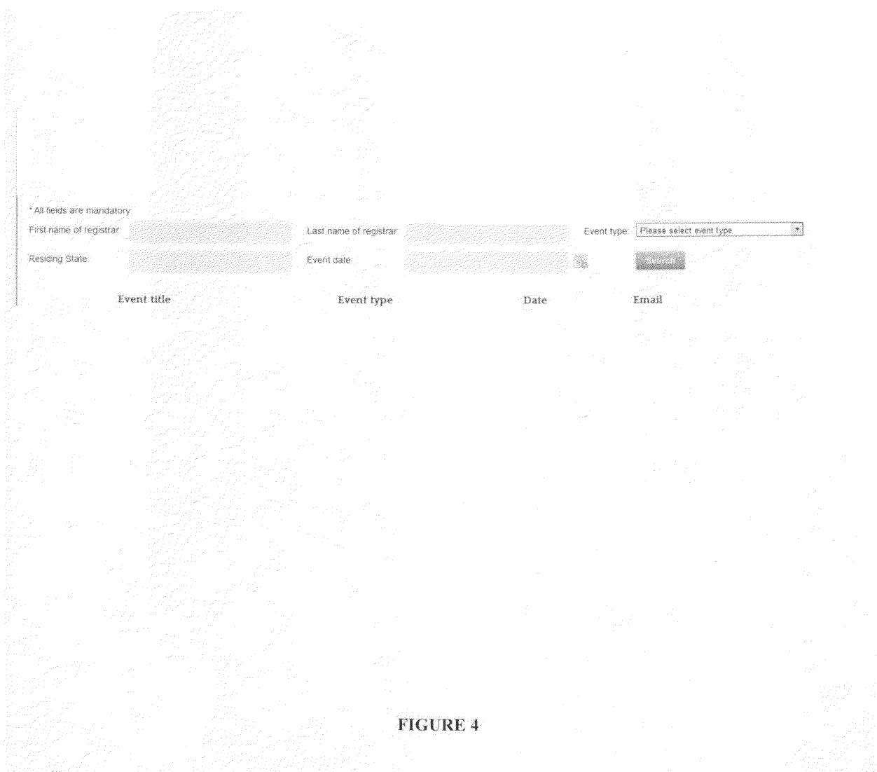

FIG. 4 illustrates a registry search. A system generated code is provided by User. However, an alternative access to registry can be granted by knowing specific information of the User's event such as User's name, event type and date, and residing state. A list of results matching criteria will display below.

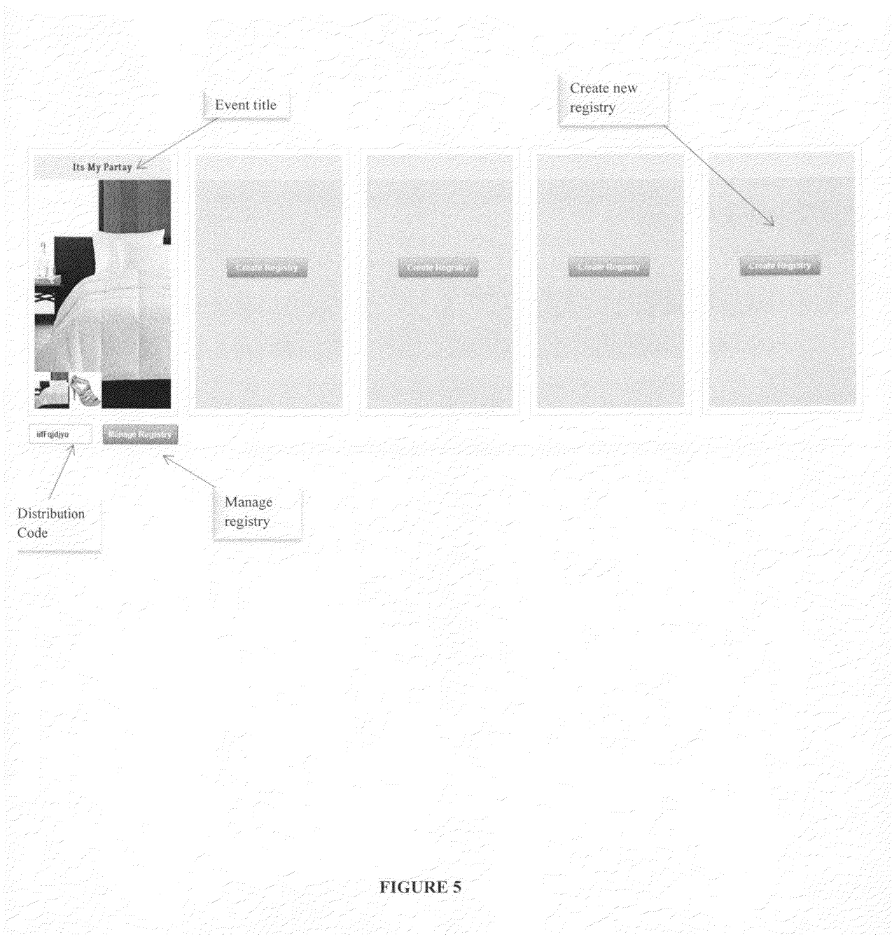

FIG. 5 illustrates the User's registry (ies). User can create up to five (5) registries and are able to manage registries on this page. Easy access buttons are below each registry. Distribution code button enables user email Guests without having to go into registry itself Manage registry button allows User to access the registry for details.

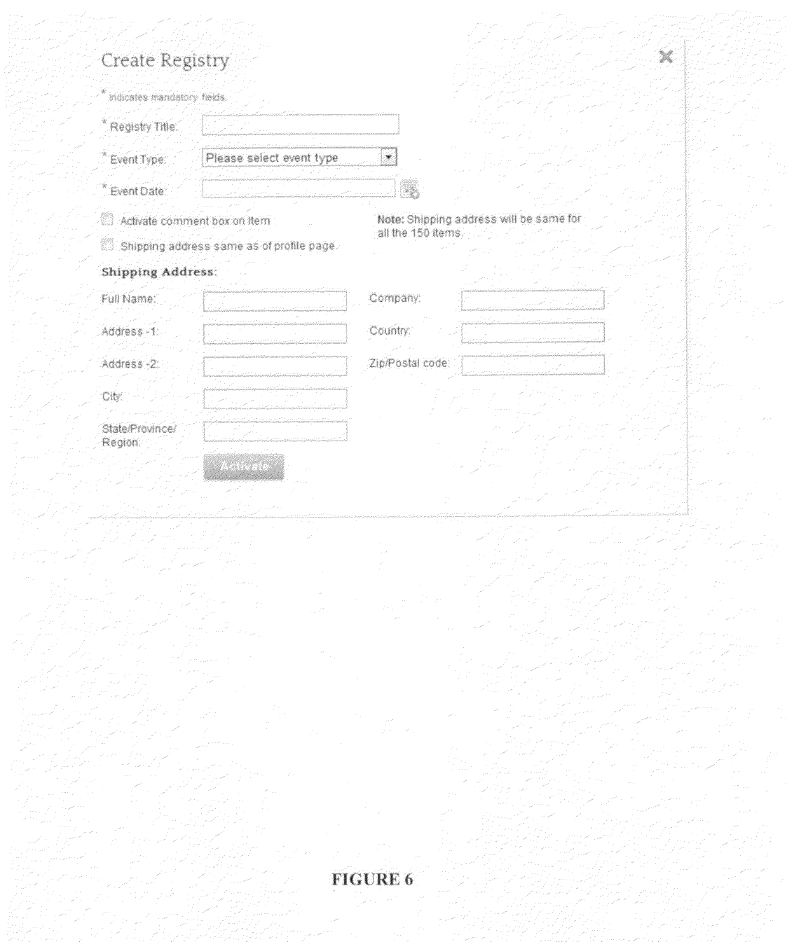

FIG. 6 illustrates criteria needed for a new registry. User information such as registry title, event type, event date, and shipping information is required for registry search. The address will be used for Guests to deliver items purchased from retailers.

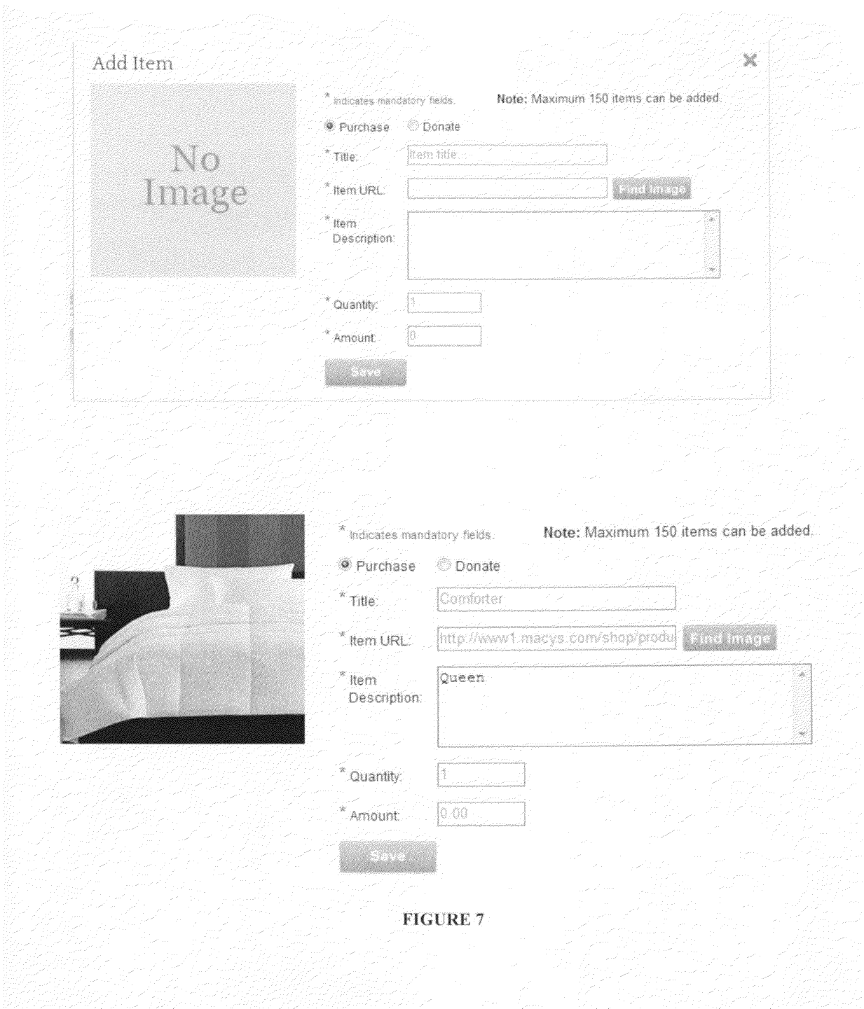

FIG. 7 illustrates the process of adding a new item to the registry. This screen enables User to request a donation towards event, or enable purchase. The buttons are identifiers used to distinguish where the registry system directs the Guest. Item URL, item descriptions, quantity and amount are added by User.

FIG. 7 further illustrates adding an item to registry by way of URL. The purchase button can be selected for items. The URL will direct Guest to the retailer's website for item purchase. However, the donate button is used for monetary donations. For example, if the User selects the donate button, the image selected by Guest will be directed to the user's PayPal account. The third-party will complete monetary transaction.

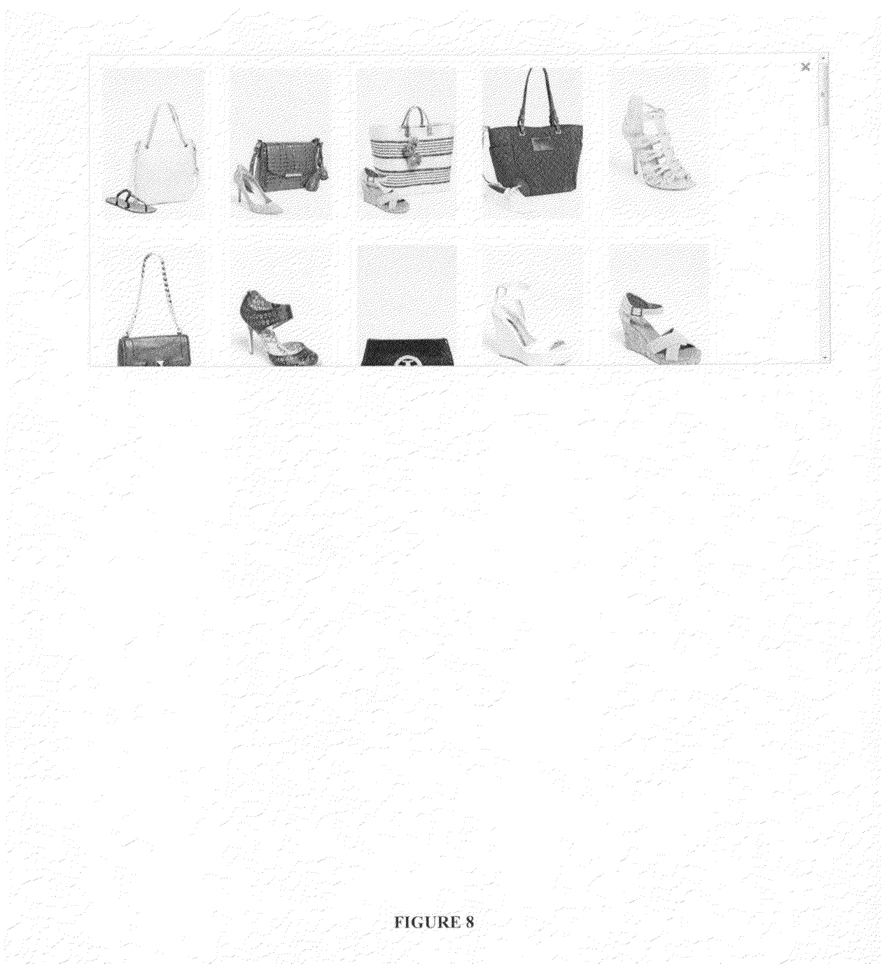

FIG. 8 illustrates image parsing once the URL is added. The registry system locates all images on such URL. User can select an image to be added to registry. Images are not limited to online retailers. This feature enables user to add images and select the donation button.

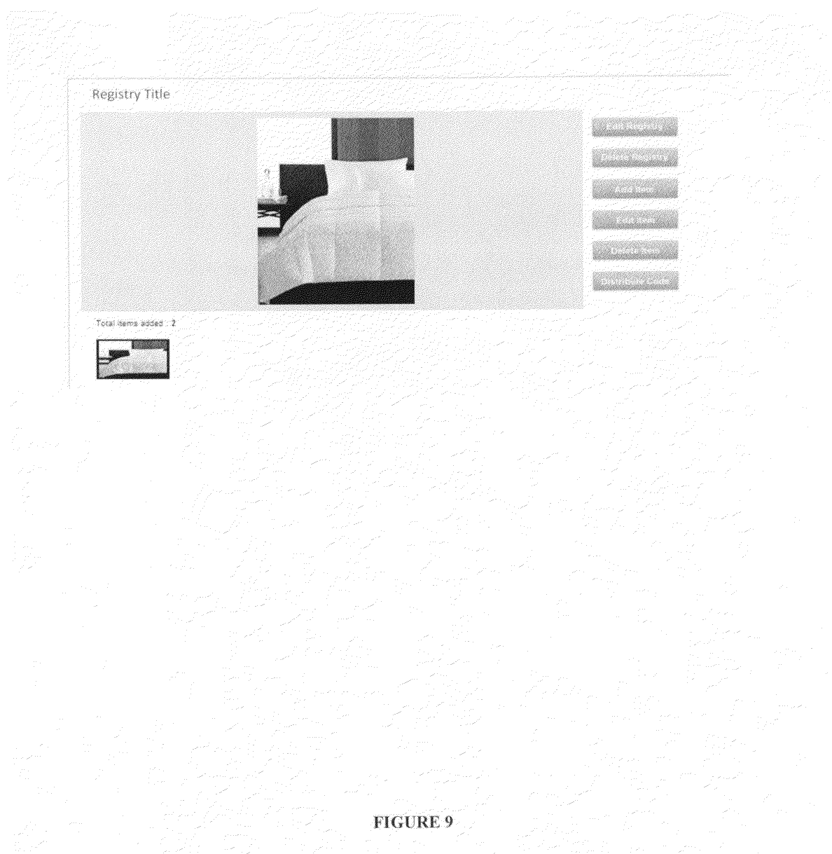

FIG. 9 illustrates the User's registry page which allows the User to maintain registry. Options to add, delete, edit, and distribute code by way of email. FIG. 9 also indicates the total number of items/donations uploaded to registry.

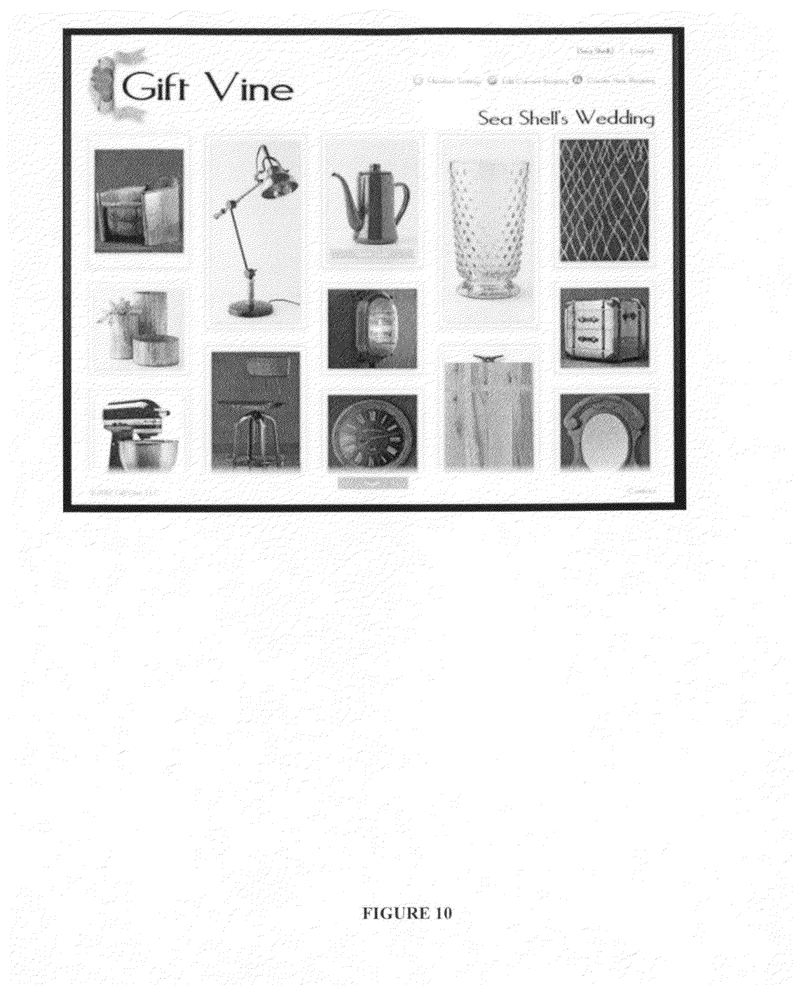

FIG. 10 illustrates the registry page visible to Guests. Images uploaded by User will be displayed in rows and/or columns. An arrow located at the bottom of the page will allow Guest to scroll to the top easily. For items which have been fulfilled, the image will be in black/white, shaded or greyed.

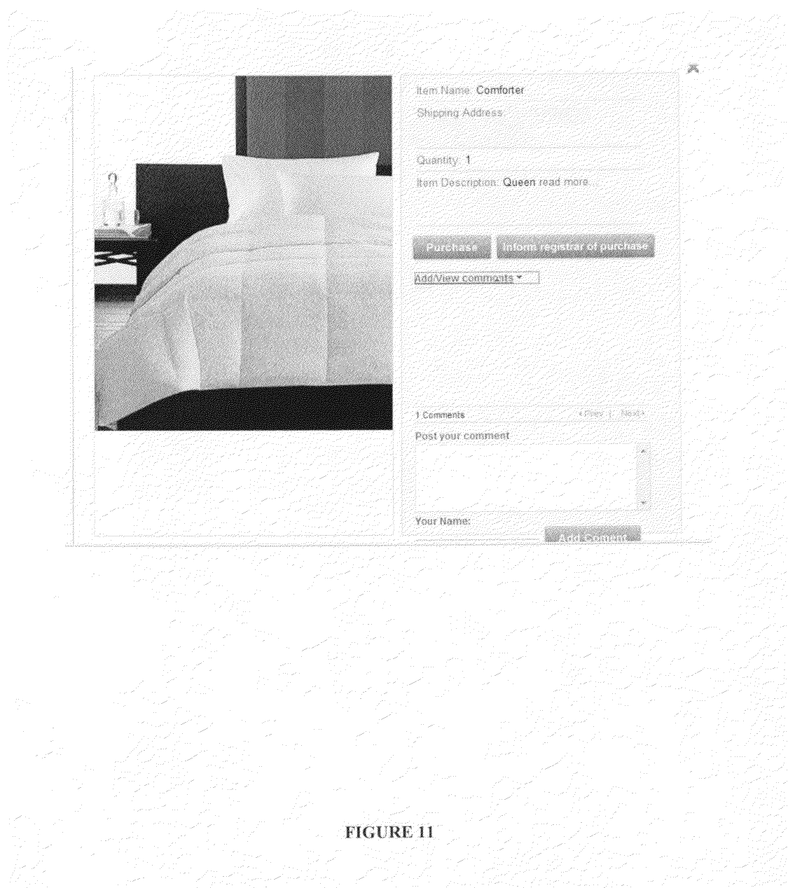

FIG. 11 illustrates an item selected by Guest. This captures detailed information about the item or donation requested. Guests have the ability to purchase the item utilizing the “purchase” button. As FIGS. 7A and 7B explain, the Guest will be directed to the retailer's website. For donations, a “Donation” button will be displayed and Guest will be taken directly to PayPal for transaction. Additional button includes “Notify User of Purchase”. This allows Guests to shop freely and notify User the item has been fulfilled outside of the retailer's website. Guests also have the ability to comment on the item. Comments will be displayed to User and other Guest who have access to registry.

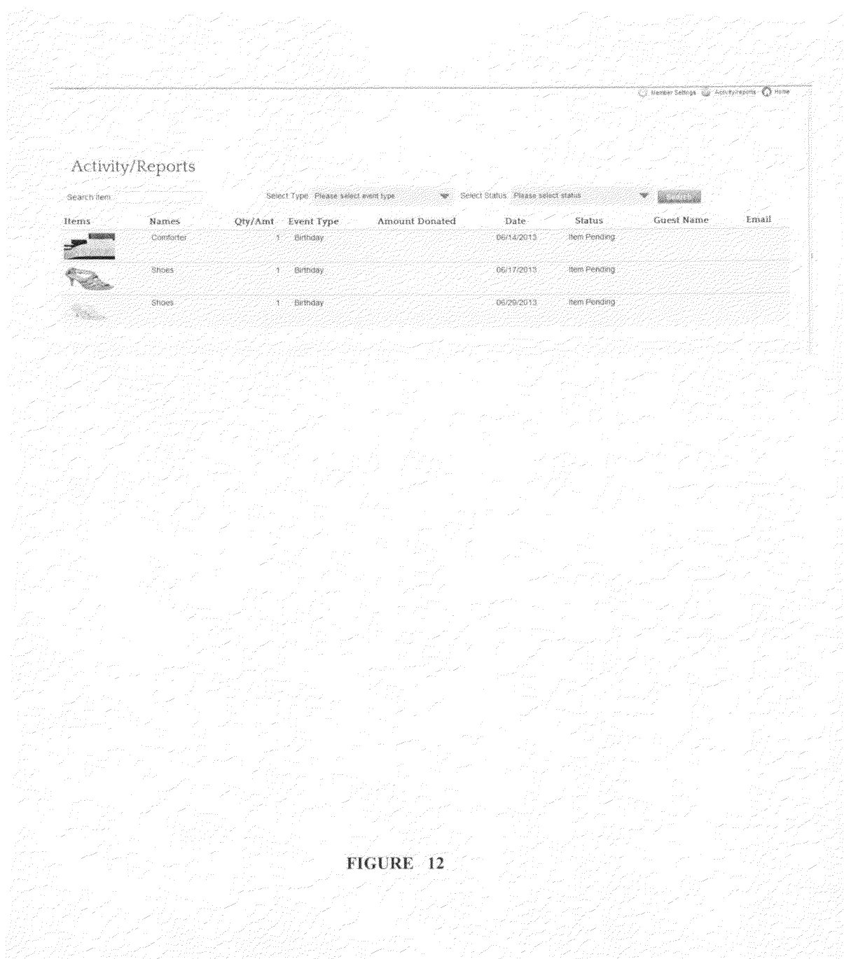

FIG. 12 illustrates an Activity Report for Users. The activity report displays items fulfilled, items pending, monetary donations made, and by which Guest. Additionally, User can filter by event or status of item.

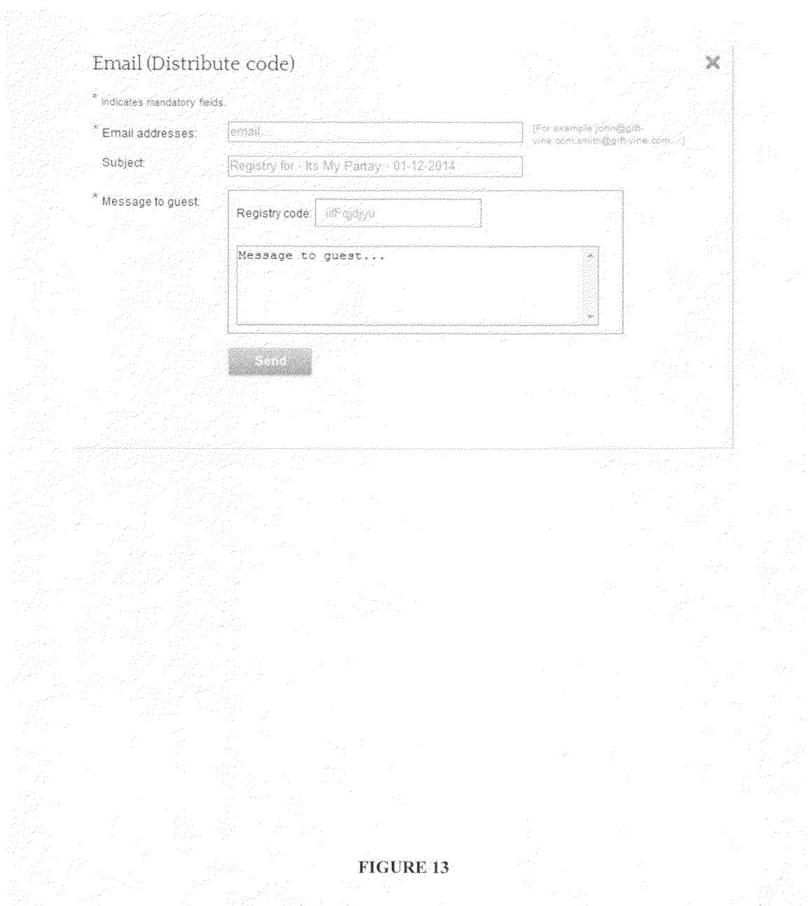

FIG. 13 illustrates a distribution code email. As FIG. 5 and FIG. 9 explain, User can distribute code to Guests. An email message, which includes guest access code and link to registry system. Further, User can personalized message sent to Guests.

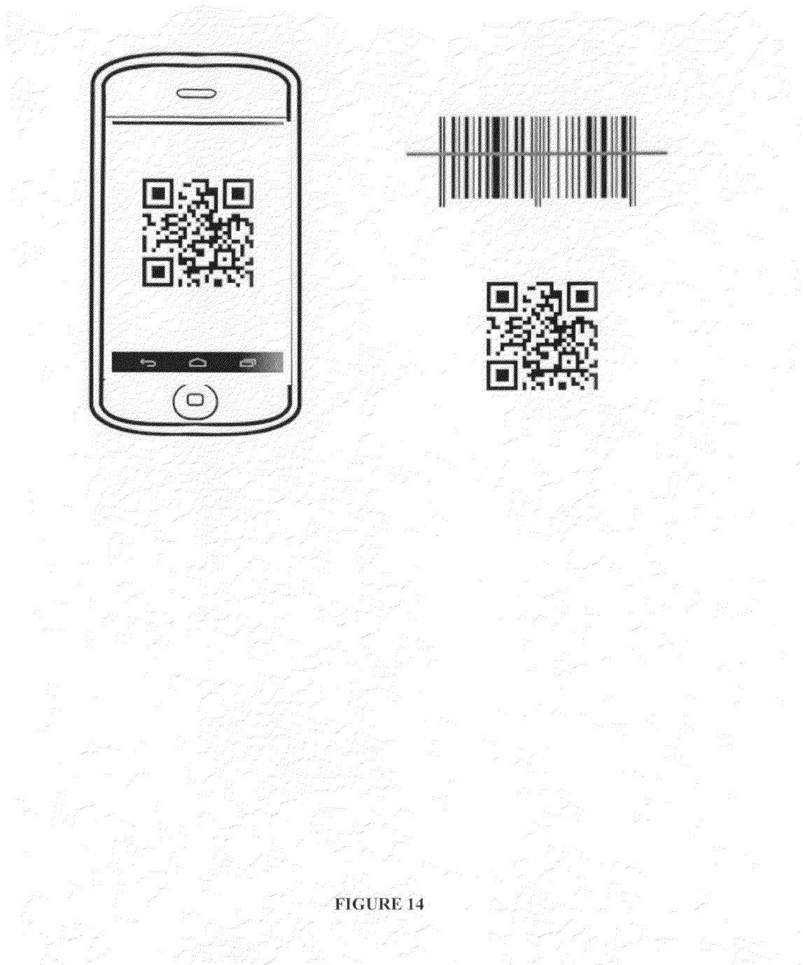

FIG. 14 illustrates an exemplary and process of using a smart phone or tablet to scan the QR or barcode. User must install an application prior to using this method. Items scanned can be added to User's registry. For example, if User is shopping at a retail store they have the ability to scan the barcode or QR and add it to their registry.

What is claimed:

1. An interactive and all-inclusive online gift registry system and method comprising: a system configured to collect content from a third-party's network to a user's personalized registry. The gift registry is configured to: save User's personal information, display items selected by User, track items and donations made by Guests, incorporate social media and interactive websites.

2. The gift registry system and method of claim 1, wherein the gift registry system is further configured to: add a third-party retailer's URL onto registry for direct access to item and image retrieval.

3. The gift registry system and method of claim 2, wherein the gift registry system is further configured to: enable User to select an item for purchase or donate; User's Guests can view the collection of items by way of images on the user's registry. The registry system directs Guests to third-party retailer's website by selecting image on registry.

4. The gift registry system and method of claim 2, wherein the gift registry system is further configured to: enable option for guest to donate monetary funds directly to third-party (PayPal) account to complete the transaction. This method enables User to request monetary funds indirectly by way of adding an image of their destination honeymoon, photographer, event venue, etc. Guests can make monetary donations towards event vendors as a gift.

5. The gift registry system and method of claim 1, wherein the gift registry system is further configured to: return a registry code upon creating a registry; User has ability to distribute code to Guests. The registry system generated code grants access to Guests without initiating an account.

6. The gift registry system and method of claim 1, wherein the gift registry system is further configured to: store and track activity of gifts purchased and donations received, including Guests email address, item, quantity or amount received and status.

7. The gift registry system and method of claim 1, wherein the gift registry system is further configured to: store historical data including historical events for each day of the year until user deletes existing account from registry system or deletes registry from system.

8. The gift registry system and method of claim 1, wherein the gift registry system is further configured to: incorporate mobile version of registry system; utilize a smart phone or tablet to scan item's bar code or QR and upload via phone by way of application.

9. The gift registry system and method of claim 1, wherein the gift registry system is further configured to: incorporate social media and interactive websites, including but not limited to Facebook and Twitter. User can access registry system by using their login information of such sites; registry system also enables User to add items to their registry; items are interfaced onto their social media page for others to view

10. The gift registry system and method of claim 1, wherein the gift registry system is further configured to: display Guests comments on items added by registry. Comments are visible to both User and other guests.

11. The gift registry system and method of claim 1, wherein the gift registry system is further configured to: identify items fulfilled; images of items or donations fulfilled will be in grey color to help distinguish which items are pending and those fulfilled.

12. The gift registry system and method of claim 1, wherein the gift registry system is further configured incorporate advertising space including but not limited to vendors and retailers. Image will be displayed on User's registry and will appear similar to the items uploaded by User.
